(19) United States
(12) Patent Application Publication
(10) Pub. No.: US 2004/0218724 A1
(43) Pub. Date: Nov. 4, 2004

(54) Miniature x-ray emitter

(76) Inventors: Victor I. Chornenky, Minnetonka, MN (US); Vance E. Swanson, Santa Rosa, CA (US); Zirao Zheng, Santa Rosa, CA (US); Eunsung Park, Minneapolis, MN (US)

Correspondence Address: MEDTRONIC VASCULAR, INC., IP LEGAL DEPARTMENT, 3576 UNOCAL PLACE, SANTA ROSA, CA, 95403, US

(21) Appl. No.: 10/427,780

(22) Filed: Apr. 30, 2003

(51) Int. Cl. H01J 35/12; H01J 35/10

(52) U.S. Cl. 378/141

(57) ABSTRACT

An x-ray radiation emitter is provided which comprises an insulating shell, a cap coupled thereto for defining a vacuum chamber, a cathode positioned within the vacuum chamber, and an anode having a distal end disposed proximate the cathode within the vacuum chamber and made of material substantially transparent to x-rays. A layer of target metal disposed on the distal end of the anode is also provided for emitting x-rays when struck by electrons emitted from the cathode upon the application of an electric field between the cathode and the anode.

### TECHNICAL FIELD

This invention relates generally to a miniature implantable x-ray apparatus, for performing intraoperative radiation treatment (IORT) of marginal tissue surrounding a surgically removed tumor or other body cavity, and more particularly to an improved, high efficiency, x-ray emitter for use in an x-ray catheter.

### BACKGROUND OF THE INVENTION

The medical community is constantly striving for less invasive techniques to treat cancer patients. For example, in the not-too-distant past, treatment for breast cancer generally required a mastectomy which is a surgical procedure involving removal of the entire breast. More recently, women have been afforded an option which is referred to as a lumpectomy; i.e. a less drastic form of surgery which involves removing only the tumor and a portion of the surrounding tissue. In fact, clinical studies have generally shown that a lumpectomy combined with postoperative radiation therapy is as effective as a mastectomy with respect to patient survival rate and probability of remaining cancer free. Since a lumpectomy preserves healthy breast tissue, it is often referred to as breast conservation surgery. For these reasons, a lumpectomy followed by breast radiation is now the preferred treatment for women with primary breast cancer; i.e. 80% of women who presently have breast cancer have tumors treatable by lumpectomy. Such treatment is especially appropriate and generally successful in breast cancer patients having small, non-invasive tumors.

External bream radiation therapy (EBRT) is one irradiation technique that may be utilized after a lumpectomy. An external ionizing radiation beam is directed onto the target tissue (tumor) from multiple angles. These overlapping or intersecting beams provide for the delivery of a relatively high dose of radiation on the target tissue while only slightly irradiating the healthy tissue between the beam source and the target tissue. However, in order to accommodate movements of the target volume during treatment, a larger beam width is required which limits precision and the maximum radiation dose that can be delivered by the EBRT apparatus to the target tissue or tumor bed.

EBRT is often used in combination with a temporarily implanted brachytherapy source. Brachytherapy is a cancer treatment which involves the placement of radioactive seeds or sources in the tumor itself thus delivering a high dose of radiation (i.e. higher than the dose associated with EBRT) to the tumor. By combining EBRT and brachytherapy, a patient is treated in a wider area but with a lower dose of radiation thus treating the tumor and any cancer cells in the generally surrounding tissue while at the same time providing a higher dosage of radiation which is localized at the tumor itself and the immediately surrounding tissue.

The most frequently used brachytherapy radiation source, Iridium-192, is used in high-dose-rate (HDR) afterloaders of the type produced by, for example, Nucletron, Inc. located in Columbia, Md. In an afterloader, a single, tiny (e.g. 1 mm×3 mm), highly radioactive source of Iridium-192 is laser welded to the end of a thin, flexible, stainless steel cable. The afterloader directs the cable through catheters or applicators placed in the patient by a brachytherapy physician. The radiation source travels through each catheter in, for example, 5 millimeter steps referred to as dwell positions. The radiation distribution and the dose is determined by the location of the dwell positions and the length of dwell. After each treatment, the source is retracted back into the afterloader. This ability to control the radiation doses permits prescribed doses to be delivered to the tumor while minimizing irradiation of nearby normal tissue, and since Iridium-192 is highly radioactive, the length of each treatment is in the order of minutes rather than days. While a program of brachytherapy treatment may only require from three to ten treatments depending on the type of cancer being treated, the technique has certain drawbacks. For example, not only is it very costly, but also operating rooms must be provided with an especially high degree of radiation protection.

U.S. patent application Ser. No. P1181 entitled Miniature X-ray Apparatus and filed on even date herewith describes an x-ray catheter which comprises a coaxial cable and a miniature x-ray emitter connected to the distal end of the coaxial cable. The x-ray emitter comprises an anode and a cathode assembly mounted in a miniature vacuum tube. To activate the system, a high voltage (typically in the neighborhood of 15-50 kV) is applied to the anode by means of the coaxial cable. The resulting high electric field at the cathode surface results in electron emission from the cathode. The electrons are emitted into a vacuum gap between the anode and the cathode and are accelerated by the electric field thus striking the anode and radiating x-ray energy as the electrons are decelerated and stopped by the anode. External to the patient's body, the cable is secured to a pull-back device that moves the emitter along a blood vessel or other body cavity as it is being irradiated. This x-ray catheter may be utilized for the intravascular radiation of coronary arteries so as to prevent restenosis after percutaneous translumenal coronary angioplasty (PTCA), for the interoperative radiation of marginal tissue surrounding a surgically removed tumor, or for other conditions in human blood vessels or other body cavities.

Typically, solid tungsten anodes are utilized which absorb all x-ray radiation emitted in the generally forward direction as viewed along the direction of electron flow from the cathode (i.e. in the forward and somewhat side forward directions). Only radiation emitted from the side and somewhat backward directions in the vacuum gap is available for therapeutic irradiation. Thus, known miniature emitters used in x-ray catheters exhibit a relatively low efficiency; i.e. a low amount of x-ray energy produced per unit of electrical energy provided at the emitter. This low efficiency results in extended treatment time.

In view of the foregoing, it should be appreciated that it would be desirable to provide a high efficiency, miniature x-ray emitter for use in the treatment of diseases such as breast cancer, prostate cancer, etc.

### SUMMARY OF THE INVENTION

In accordance with an aspect of the invention, there is provided an x-ray radiation emitter comprising an insulating shell, a cap coupled thereto for defining a vacuum chamber, a cathode positioned within the vacuum chamber, and an anode having a distal end disposed proximate the cathode within the vacuum chamber and made of material substantially transparent to x-rays. A layer of target metal disposed on the distal end of the anode is provided for emitting x-rays when struck by electrons emitted from the cathode upon the application of an electric field between the cathode and the anode.

### BRIEF DESCRIPTION OF THE DRAWINGS

The following drawings are illustrative of particular embodiments of the invention and therefore do not limit the scope of the invention, but are presented to assist in providing a proper understanding of the invention. The drawings are not to scale (unless so stated) and are intended for use in conjunction with the explanations in the following detailed description. The present invention will hereinafter be described in conjunction with the appended drawings, wherein like reference numerals denote like elements, and:

FIG. 1 is a diagrammatic illustration, partially in cross-section, of a miniature high-dose-rate x-ray apparatus for performing intraoperative radiation therapy;

FIG. 2 is a cross-sectional view of a miniature x-ray emitter in accordance with a first embodiment of the present invention;

FIG. 3 is a cross-sectional view of the x-ray emitter shown in FIG. 2 taken along line 3—3;

FIG. 4 is a cross-sectional view of a miniature x-ray emitter exhibiting a doughnut-like radiation pattern and having a relatively thick target; and

FIG. 5 is a cross-sectional view of a miniature x-ray emitter exhibiting a doughnut-like radiation pattern and having a relatively thin target in accordance with the teachings of the present invention.

### DETAILED DESCRIPTION OF THE EXEMPLARY EMBODIMENTS

The following description is exemplary in nature and is not intended to limit the scope, applicability, or configuration of the invention in any way. Rather, the following description provides a convenient illustration for implementing exemplary embodiments of the invention. Various changes to the described embodiments may be made in the function and arrangement of the elements described herein without departing from the scope of the invention.

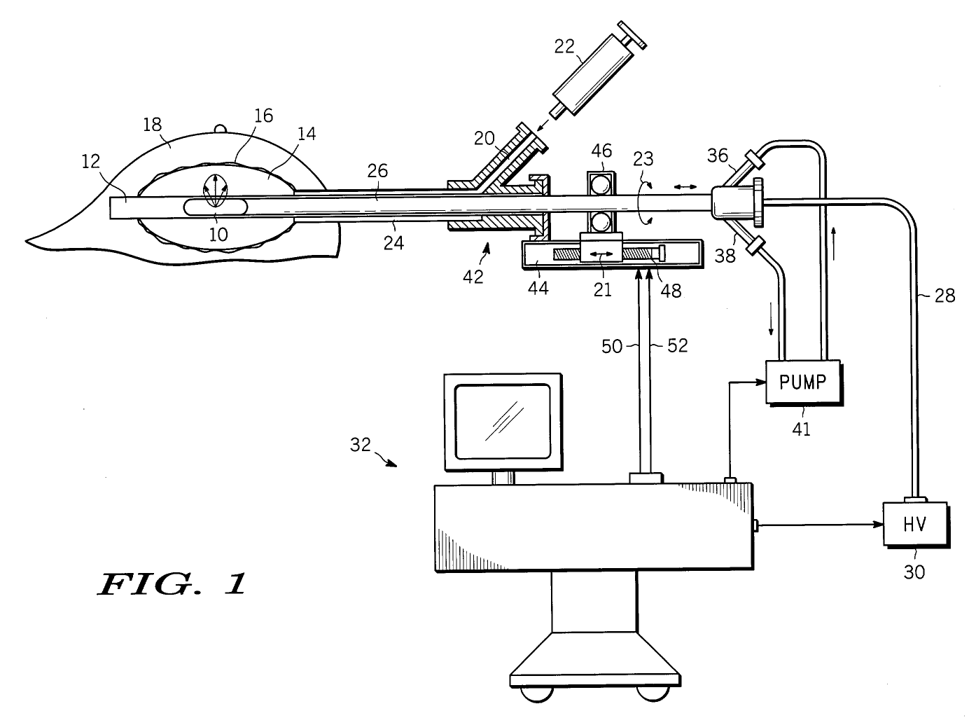

FIG. 1 is a diagrammatic illustration, partially shown in cross-section, of a miniature high-dose-rate x-ray apparatus for performing intraoperative radiation therapy on a breast cancer patient in accordance with the teachings of the present invention. As can be seen, an x-ray emitter 10 is positioned within a flexible introducer guide 12 having a balloon 14 secured thereon. Flexible introducer guide 12 may be made of a flexible plastic, metal, or any other material suitable for the intended purpose. Balloon 14 may be made from soft compliant polymers, for example latex, so as to permit balloon 14 to conform to a cavity 16 when inflated as will be described below. It should be appreciated that although it has been stated above that balloon 14 may consist of soft compliant polymer materials, other materials which possess the characteristics and properties suitable for the intended purpose may be employed.

Introducer guide 12 is inserted into a patient's breast 18 through small surgical incisions, and balloon 14, now in a collapsed or deflated configuration and closely surrounding introducer guide 12, is positioned within surgical cavity 16 which was left in breast 18 as a result of the surgical removal of a malignant tumor. Balloon 14 is in fluid communication with catheter port 20 and syringe 22 by means of a channel 24. Thus, upon proper positioning of the collapsed balloon 14 proximate cavity 16, balloon 14 may be inflated by injecting fluid into the balloon via syringe 22, catheter port 20 and communication channel 24 so as to prepare cavity 16 for irradiation.

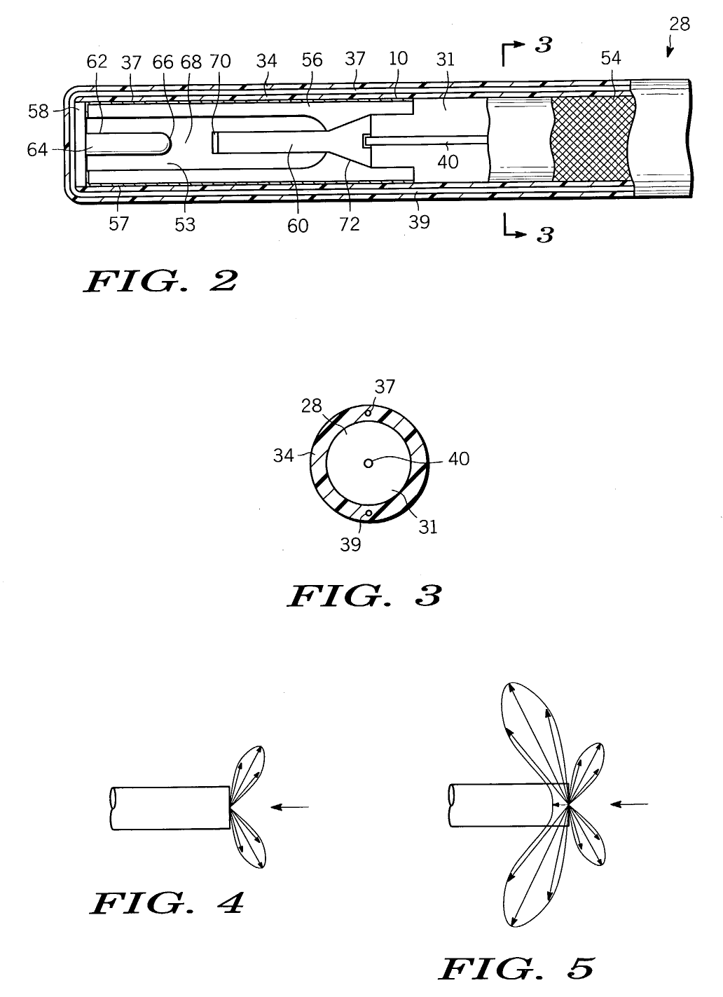

X-ray catheter 26 includes x-ray emitter 10 which is coupled by means of, for example, a high voltage coaxial cable 28 (having an outer conductor or braid 54, an insulating layer 31, and a center conducer 40 shown in FIG. 2) to a high voltage source 30 (e.g. 30-50 kV and capable for delivering several watts of power). High voltage power source 30 is in turn coupled to and controlled by a computerized controller 32 which controls, among other things, the area of irradiation and the delivered dosage.

X-ray catheter 26 also includes a plastic or metal catheter sheath (34 in FIG. 2 and FIG. 3) positioned over coaxial cable 28 and provided with first and second relatively small diameter ports 36 and 38 respectively. Port 36 is a catheter input port, and port 38 is a catheter output port. A pump 41 controlled by controller 32 pumps coolant into input port 36. The coolant then flows through channel 37 in catheter sheath 34, around x-ray emitter assembly 20, through channel 39, and is retrieved at output port 38. This flow of coolant around emitter 10 serves to cool the emitter during operation. FIG. 3 is a cross-sectional view of the emitter assembly shown in FIG. 2 and more clearly illustrates central conductor 40, insulating layer 31, catheter sheath 34, input channel 37, and output channel 39.

Referring again to FIG. 1, the proximal end 42 of introducer guide 12 is secured to a pull-back device 44 which is configured to move x-ray catheter 26 inside introducer guide 12 both longitudinally and rotationally as is indicated by arrows 21 and 23 respectively to provide a required irradiation pattern to the marginal tissue surrounding the excised tumor. Thus, pull back device 44 includes a rotational stage 46 that produces rotation of x-ray catheter 26 about its own axis, and includes a translational stage 48 that provides for longitudinal movement of x-ray catheter 26. Both rotational and longitudinal movement of x-ray catheter 26 by means of rotational stage 46 and translational stage 48 respectively occurs in response to signals from computerized controller 32 as is indicated by connections 50 and 52.

FIG. 2 is a cross-sectional view of a high efficiency miniature x-ray emitter in accordance with the teachings of the present invention which can be utilized in the miniature high-dose-rate x-ray apparatus shown in FIG. 1. A coaxial cable 28 having braid 53 and a second or center conductor 40 is coupled to an x-ray emitter 10. Braid 53 is coupled to a metallic coating 57 (e.g. titanium-silver) disposed on an insulating shell 56. Emitter 10 comprises a vacuum chamber 54 formed by insulating shell 56 (e.g. quartz) and a brazing or end cap 58 (e.g. made of a suitable metal such as molybdenum, tungsten, nickel, etc.) which forms a vacuum seal with insulating shell 56. Within vacuum chamber 54, there is an anode 60 coupled at one end thereof to center conductor 40 of coaxial cable 28 and a cathode 62. Cathode 62 consists of brazing cap 58, a getter 64 for maintaining a vacuum within vacuum chamber 54, and a diamond like carbon (DLC) coating 66 on the tip of getter 64 for providing electron field emission. Getter 64 may be made of, for example, a STO7 alloy available from SAES in Colorado Springs, Colo. Anode 60 and cathode 62 are situated at the proximal and distal ends respectively of vacuum chamber 53. The positioning of anode 60 and cathode 62 creates a vacuum gap 68 (e.g. having a length of 300-500 microns) between and separating anode 60 from cathode 62. A thin film 70 is deposited on the tip of anode 60 and serves as a target for the electrons emitted from cathode 62. As the electrons which have been accelerated to approximately 15-35 keV impinge on film 70, x-rays are generated and emitted in all directions due to the impact and deceleration of electrons emitted from cathode 62 on and within thin film 70.

As suggested previously, if a solid tungsten anode is utilized, all x-ray radiation emitted in the generally forward direction as viewed along the direction of electron flow from the cathode (i.e. in the forward and somewhat side forward directions) will be absorbed. Only radiation emitted from the side and somewhat backward directions in the vacuum gap is available for therapeutic irradiation as is shown in FIG. 4. Returning to FIG. 1, the main body of the anode is formed from a metal which is transparent to x-rays, preferably beryllium, which does not significantly absorb radiation emitted in the forward and side forward directions. Thus, more radiation is available for treatment purposes. Only radiation which is emitted along the emitter axis will be prevented from reaching the wall of the emitter since it will be absorbed by getter 64 and coaxial cable 28 attached to anode 60. Thus, radiation propagating within a range of approximately plus or minus 45 degrees from both sides of target film 70 will reach the emitter wall and deliver a radiation dose as is shown in FIG. 5.

X-rays having an energy range of between 10 and 100 keV are emitted predominately in side forward directions with a maximum emitted energy between 10 and 30 degrees from the plane of the target film. For a more detailed discussion, the interested reader is directed to Physics of Radiology, Harold E. Johns, John R. Cunningham, 4^{th} edition (December 1983), page 67. This side forward radiation is two to three times higher than the side backward maximum which is achievable using prior art devices. Thus, the inventive emitter can produce almost a threefold increase in overall production of usable x-ray energy.

Target film 70 can be made of any heavy metal which is routinely used for targets such as tungsten, gold, or the like. In accordance with the teachings of the present invention, the target film can be made not only from a heavy metal, but also from metals having characteristic x-ray emission lines in the required energy range. For example, molybdenum and yttrium have characteristics in the 17-19 keV range and the 15-16 keV range respectively. Thus, targets made from these metals will efficiently generate radiation having a depth of penetration into tissue of between about 5-8 millimeters Half Value Layer (HVL), which is appropriate for the radiation of coronary vessels.

The thickness of target film 70 should be comparable with the electron free range in the selected target metal. As an electron moves in the target material, its energy gradually transfers to the medium or is irradiated in the form of x-ray radiation. At any given moment, it can emit x-ray quantum within a wide range of energies from zero to a maximum value equal to its own energy. Thus, x-rays with the highest energy are emitted as the electron enters the medium. At some distance from its entry into the target, an electron starts emitting x-ray radiation with an energy that is too low to be useful for the irradiation of a vessel or cavity wall. That is, x-rays having energy lower than approximately 10 keV do not penetrate to a necessary depth and only contribute excessive irradiation to the inner surface of the wall or cavity. Thus, to avoid this excessive radiation, the low range of energies should be filtered out; i.e. absorbed by a layer of metal coating on the outside surface of the shell. By limiting the thickness of the thin target, significant suppression of low energy emission can be achieved. Target thickness may be selected in such a way that the average energy of the electrons drops below 10 keV as they pass the target and enter the beryllium substrate. In this case, the remaining energy will be converted into heat and virtually no x-rays will be emitted. Thus, by appropriately selecting the thickness of the thin target, a significant improvement in the emissions spectrum can be achieved without resorting to filtration.

The free range L of electrons in different media can be calculated from the formula:

L=(4*10⁻¹⁰)(v^{1.5})/d,

where v is voltage in volts, and d is density in grams per cubic centimeter (cc). A discussion of this formula can be found in “Breakdown Mechanism of Short Vacuum Gaps”, Kassimov and Mecyats, Soviet Physics—Technical Physics; vol. 9; No. 8, February 1965. Using this formula, and substituting 25 kV for the voltage, the optimal thickness of a tungsten film is approximately 0.33 micrometers, and the optimal thickness of an yttrium film is 1.42 micrometers. In arriving at these results, the energy loss was assumed to be linear with distance.

Referring again to FIG. 2, beryllium anode 60 can be joined to an insulating shell 56 (e.g. quartz) by brazing. Beryllium has a stable oxide on its surface that must be removed before the joining process. This can be achieved by pickling the beryllium in an acid solution followed by rinsing with deionized water in an ultrasonic bath. After preparing the surface to be joined, the beryllium surface is metallized with 2-3 microns of silver or titanium using a vacuum deposition technique such as sputtering. This is required to enhance wettability. The quartz surface must also be metallized prior to the brazing process since non-active braze filler metals will not wet the quartz surface. This can be accomplished by applying titanium using a high energy physical vapor coating method such as cathodic arc deposition. A high energy coating method is required to ensure an even coating of titanium on the tapered surface 72 of quartz shell 56. After premetallization of the beryllium and quartz surfaces, pure tin is used as a braze filler metal. Low melting point braze filler metals are required for brazing quartz because quartz goes through detrimental phase transformation at 573 degrees centigrade. Tin will react with silver or titanium during the brazing process resulting in good metallic bonding.

The brazing temperature can range from 450 degrees Centigrade to 600 degrees Centigrade, and at the end of the brazing cycle, the brazed assembly is cooled very slowly to minimize thermal stresses on the quartz. The joining of quartz using a tin-titanium system is described in detail in U.S. patent application Ser. No. 09/760,815 filed Jan. 17, 2001 and entitled “Miniature X-ray Device and Method of its Manufacture.”

Thus, there has been provided an improved, high-efficiency emitter and x-ray catheter for use in a miniature x-ray apparatus. The anode of the emitter is comprised of a material which is transparent to x-rays such as beryllium, and a relatively thin target layer; e.g. tungsten. This produces a significant increase in the amount of usable x-ray energy.

In the foregoing specification, the invention has been described with reference to specific embodiments. However, it may be appreciated that various modifications and changes can be made without departing from the scope of the invention as set forth in the appended claims. Accordingly, the specification and figures should be regarded as illustrative rather than restrictive, and all such modifications are intended to be included within the scope of the present invention

What is claimed is:

1. An x-ray radiation emitter, comprising:
an insulating shell;
a cap coupled to said insulating shell for defining vacuum chamber;
a cathode disposed within said vacuum chamber;
an anode having a distal end disposed proximate said cathode within said vacuum chamber, said anode made of material substantially transparent to x-rays; and
a layer of target metal on said distal end of said anode for emitting x-rays when struck by electrons emitted by said cathode upon the application of an electric field between said anode and said cathode.

2. An x-ray apparatus according to claim 1 wherein said material is beryllium.

3. An x-ray apparatus according to claim 2 wherein said target metal is a heavy metal.

4. An x-ray apparatus according to claim 3 wherein said heavy metal is tungsten.

5. An x-ray apparatus according to claim 3 wherein said heavy metal is gold.

6. An x-ray apparatus according to claim 3 wherein said heavy metal is yttrium.

7. An x-ray apparatus according to claim 4 wherein the thickness of said target metal is approximately 0.33 micrometers.

8. An x-ray apparatus according to claim 6 wherein the thickness of said heavy metal is approximately 1.42 micrometers.

9. An x-ray apparatus according to claim 3 wherein said insulating shell in quartz.

10. An x-ray apparatus for delivering x-ray radiation to interior surface tissue of a body cavity, comprising:
a flexible introducer guide having a distal end and a proximal end, said distal end for insertion into said body cavity;
a flexible x-ray catheter configured for movement within said introducer guide, said x-ray catheter having a distal end and a proximal end;
an x-ray emitter coupled to the distal end of said x-ray catheter for generating x-rays to irradiate said interior surface tissue, said x-ray emitter configured for coupling to a high voltage source, said x-ray emitter comprising:
an insulating shell having a vacuum chamber defined therein;
a cathode disposed within said vacuum chamber;
an anode having a distal end disposed proximate said cathode within said vacuum chamber, said anode made of material substantially transparent to x-rays; and
a layer of target metal on said distal end of said anode for emitting x-rays when struck by electrons emitted from said cathode upon the application of an electric field between said anode and said cathode.

11. An x-ray apparatus according to claim 10 further comprising a controller coupled to said x-ray catheter for controlling the area of irradiation and the delivered dosage.

12. An x-ray apparatus according to claim 10 further comprising:
an inflatable balloon mounted proximate the distal end of said flexible introducer guides; and
first means for selectively inflating said balloon.

13. An x-ray apparatus according to claim 11 wherein said x-ray emitter is coupled to the high voltage source by a flexible cable having first and second conductors, said first conductor being coupled to said high voltage source and insulated from said second conductor.

14. An x-ray apparatus according to claim 13 wherein said flexible cable is a coaxial cable having a center conductor and an outer conductor which is insulated from said center conductor.

15. An x-ray apparatus according to claim 13 further comprising first means coupled to said controller and to said x-ray catheter for moving said x-ray catheter within said introducer guide.

16. An x-ray apparatus according to claim 15 wherein said controller selectively moves said x-ray catheter in translational and rotational directions within said introducer guide.

17. An x-ray apparatus according to claim 16 further comprising:
a channel in said x-ray catheter; and
cooling means for pumping a coolant through said channel to cool said emitter.

18. An x-ray apparatus according to claim 15 wherein said insulating shell is quartz.

19. An x-ray apparatus according to claim 18 wherein said flexible introducer guide is a flexible plastic.

20. An x-ray apparatus according to claim 18 wherein said flexible introducer guide is a flexible metal.

21. An x-ray apparatus according to claim 12 wherein said balloon is a polymeric material.
